(19) United States
(12) Patent Application Publication
(10) Pub. No.: US 2018/0375846 A1
(43) Pub. Date: Dec. 27, 2018

(54) TRANSMISSION-ONLY MESH NODES

(71) Applicant: QUALCOMM Incorporated, San Diego, CA (US)

(72) Inventor: Robin HEYDON, Cambridge (GB)

(21) Appl. No.: 15/716,978

(22) Filed: Sep. 27, 2017

Related U.S. Application Data
(60) Provisional application No. 62/523,187, filed on Jun. 21, 2017.

(51) Int. Cl. H04L 29/06; H04W 48/16; H04W 84/18; H04W 12/08

(52) U.S. Cl. CPC H04L 63/08; H04W 48/16; H04W 84/18; H04W 12/04; H04L 63/123; H04L 63/061; H04W 12/08

(57) ABSTRACT

In an aspect of the disclosure, a method, a computer-readable medium, and an apparatus are provided. In certain implementations, the apparatus may determine a static security key associated with the Tx-only mesh node. In one aspect, the static security key may include a MIC. The apparatus may transmit the static security key to at least one mesh node using a first frequency channel. The apparatus may transmit at least one PDU to the at least one mesh node using a second frequency channel that is different than the first frequency channel.

### CROSS-REFERENCE TO RELATED APPLICATION

This application claims the benefit of U.S. Provisional Application Ser. No. 62/523,187, entitled “TRANSMISSION-ONLY MESH NODES” and filed on Jun. 21, 2017, which is expressly incorporated by reference herein in its entirety.

### BACKGROUND

### Field

The present disclosure relates generally to communication systems, and more particularly, to enablement of a transmission (Tx)-only mesh node for communication in a wireless mesh network (WMN).

### Background

A WMN is a distributed network of mesh nodes (e.g., wireless routers, cellular base stations, access points, relay nodes, wireless sensors, etc.) that are organized in a mesh topology, and configured to relay communications from point A to point B within the WMN. Using the distributed network of mesh nodes, signals may be carried from point A to point B by splitting the distance (e.g., from point A to point B) into a series of hops between intermediate mesh nodes. Intermediate mesh nodes not only boost/regenerate the signal, but cooperatively pass the signal from point A to point B by making forwarding decisions using knowledge of the mesh topology (e.g., the spatial relationship of the mesh nodes within the WMN).

As compared to other types of communication networks, WMNs may offer certain advantages such as increased reliability. For example, when a mesh node in the WMN malfunctions, the remaining mesh nodes may still route signals from point A to point B using an updated mesh topology that no longer includes the malfunctioning mesh node. In other words, a WMN may be able to “self-form” and “self-heal” when a mesh node in the WMN malfunctions.

A Tx-only mesh node is one type of low-power device that may be used to transmit communications in a WMN but not receive communications. Traditional Tx-only mesh nodes may not be included in a WMN for various reasons. For example, since a Tx-only mesh node may not include a receiver, it may not be possible for Tx-only mesh nodes to be provisioned by a provisioning entity, to perform security key updates and/or initialization vector (IV) updates, and/or to bind to application keys or network keys.

Thus, there is a need to provide a Tx-only mesh node that can operate in a WMN without being provisioned by a provisioning entity, performing security key updates, and/or binding to application keys or network keys.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In order to be included in a WMN, a low-power mesh node may need to 1) be provisioned by a provisioning entity such as another mesh node (e.g., provisioning may be accomplished using a receiver at the low-power mesh node that may use a 100% duty cycle), 2) establish a friendship and/or connection with one or more other mesh nodes in the WMN (e.g., establishing a friendship and/or connection may use a 100% duty cycle), 3) maintain the friendship and/or connection with the one or more mesh nodes in the WMN (e.g., maintaining a friendship and/or connection may use a 0.5% duty cycle), and/or 4) remain up to date with security updates associated with communications within the WMN (e.g., remaining up to date with security updates, such as security key updates, may use a 0.5% duty cycle). Each of 1), 2), 3), and 4) listed above may be implemented using a receiver at a mesh node, and the receiver may use power to listen for packets from other mesh nodes within the WMN.

One way of reducing the power consumption of a mesh node is to configure a mesh node as a Tx-only mesh node. Mesh nodes that include both a transmitter and receiver may have to exit a low-power state to both transmit protocol data units (PDUs) and to monitor for PDUs being sent from other mesh nodes. By excluding a receiver, a Tx-only mesh node may exit a low-power state (e.g., and enter an active power state) to transmit PDUs but not to monitor for PDUs sent from other mesh nodes. Hence, the amount of time the Tx-only mesh nodes in an active power state may be reduced, and thus, the power consumption of a Tx-only mesh node may also be reduced as compared to a mesh node that includes both a transmitter and receiver.

Another way of reducing power consumption of a mesh node is to reduce the transmission time of a PDU. The transmission time of a PDU may be reduced by omitting certain information. In certain scenarios, a PDU may include one or more security keys, a data payload, a source address of the transmitting device, and a destination address of the device for which the PDU is intended. By omitting certain information from the PDU (e.g., such as the source address and the destination address), the power consumption of a Tx-only mesh node may be further reduced.

Traditional Tx-only mesh nodes may not be included in a WMN for various reasons. For example, since a Tx-only mesh node does not include a receiver, it may not be possible for Tx-only mesh nodes to be provisioned by a provisioning entity, to perform security key updates and/or IV key updates, and/or to bind to application keys or network keys. In order to indicate the source of the PDU and the intended destination of the PDU, traditional Tx-only mesh nodes may include a source address and the destination address in a transmitted PDU.

Thus, there is a need to provide a Tx-only mesh node that is configured to operate in a WMN using reduced power consumption as compared to traditional Tx-only mesh nodes. In addition, there is a need to provide a Tx-only mesh node that is configured to operate in a WMN without being provisioned by a provisioning entity, performing security key updates, binding to application keys or network keys.

The present disclosure provides a solution by configuring a Tx-only mesh node for use in a WMN. For example, the solution may include configuring the Tx-only mesh node to determine a static security key (e.g., static shared secret) that a provisioning entity (e.g., another mesh node) may receive in an out of band frequency channel, to use a sufficiently long sequence number (SEQ) in transmissions to other mesh nodes in order to forego the use of updated security keys and/or updated IV keys, and to configure the static security key to be different than the network key (NetKey) and/or application key (AppKey) used for secure message exchange within the WMN without using a device key (DevKey).

A NetKey may be generated and distributed by a provisioner (e.g., a device used to add another device to the WMN). The NetKey may include a password used to connect to the WMN. An AppKey may be used by a mesh node (e.g., Tx-only mesh node) to derive session keys during an activation process. In certain implementations, a WMN may have a default AppKey used to activate all mesh nodes and/or mesh client devices, or a customized AppKey for each mesh node and/or mesh client device. Each mesh node may possess a unique DevKey. The DevKey may be known by an associated mesh node and the provisioner, and used to encrypt communications between the mesh node and the provisioner.

In an aspect of the disclosure, a method, a computer-readable medium, and an apparatus are provided. In certain implementations, the apparatus may determine a static security key associated with a Tx-only node. In one aspect, the static security key may include a message integrity code (MIC). The apparatus may transmit the static security key to at least one mesh node using a first frequency channel. The apparatus may transmit at least one PDU to the at least one mesh node using a second frequency channel that is different than the first frequency channel.

In certain other implementations, the apparatus may transmit a static configuration discovery message to at least one second mesh node. In one aspect, the static configuration discovery message may include a request for a report indicating any Tx-only mesh nodes. The apparatus may receive a report from the at least one second mesh node in response to the request. In one aspect, the report may indicate any Tx-only mesh nodes in the WMN. The apparatus may determine the Tx-only mesh nodes in a WMN based at least in part on the received report. The apparatus may maintain information associated with any Tx-only mesh nodes included in the report.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a WMN and an access network.

FIG. 2 is block diagram of a wireless device in accordance with certain aspects of the disclosure.

FIG. 3 illustrates a data flow between a Tx-only mesh node and one or more other mesh nodes in a WMN in accordance with certain aspects of the disclosure.

FIG. 4 is a diagram illustrating a PDU frame structure that may be used for communications by a Tx-only mesh node in a WMN in accordance with certain aspects of the disclosure.

FIG. 5 illustrates a data flow between a first mesh node and a second mesh node in a WMN in accordance with certain aspects of the disclosure.

FIG. 6 is a flowchart of a method of wireless communication.

FIG. 7 is a flowchart of a method of wireless communication.

FIG. 8 is a conceptual data flow diagram illustrating the data flow between different means/components in an exemplary apparatus.

FIG. 9 is a diagram illustrating an example of a hardware implementation for an apparatus employing a processing system.

FIG. 10 is a conceptual data flow diagram illustrating the data flow between different means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

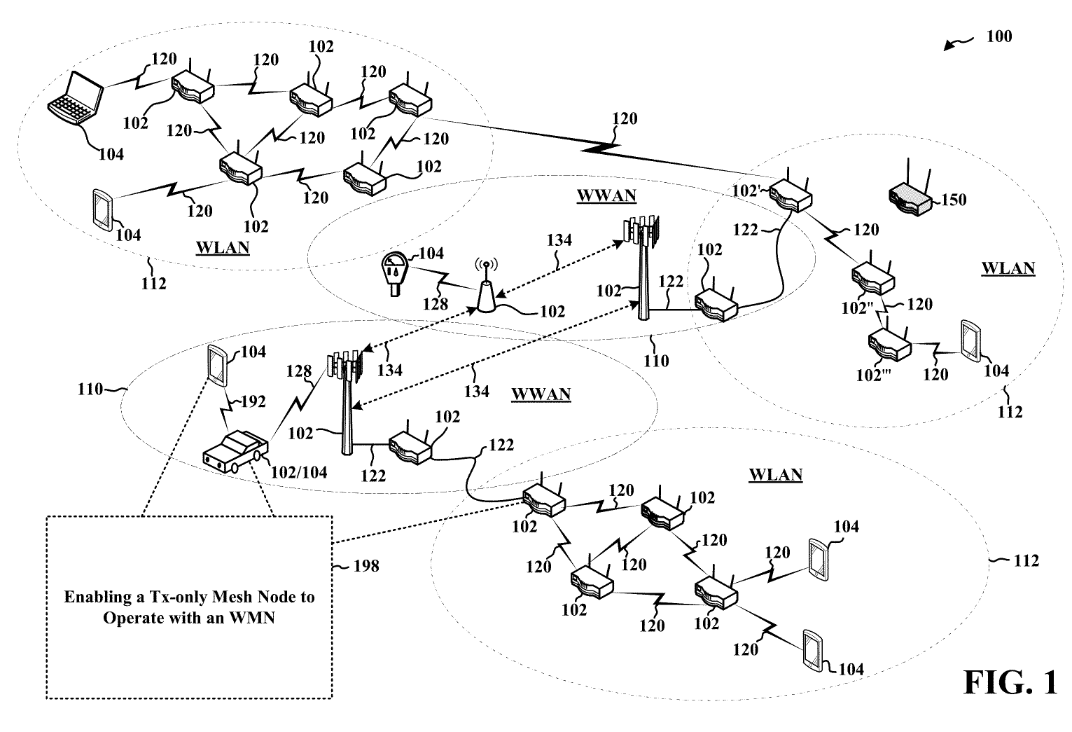

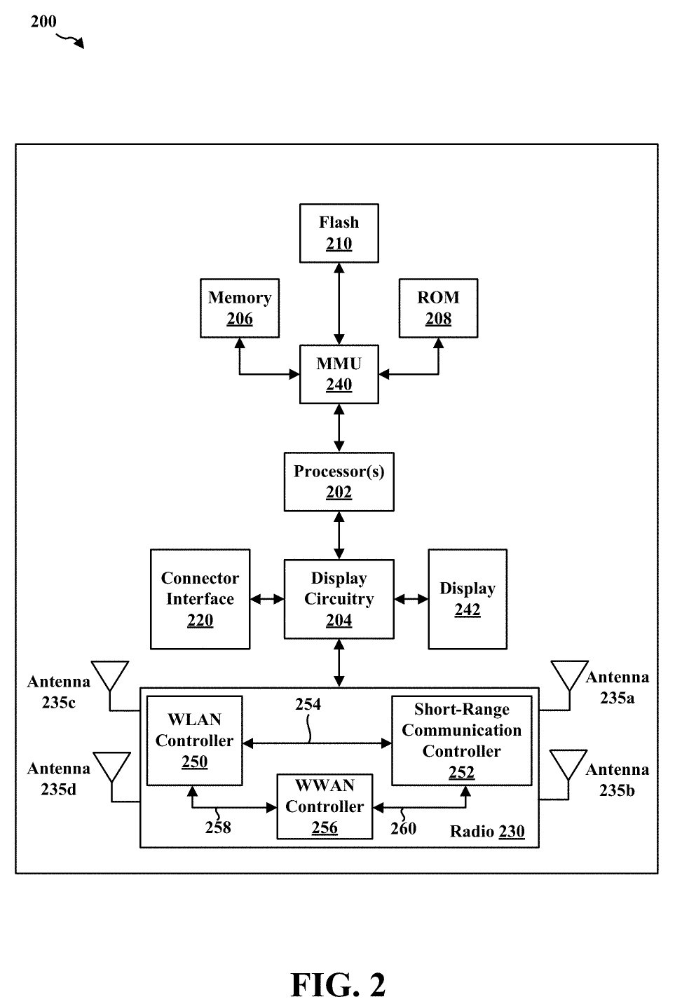

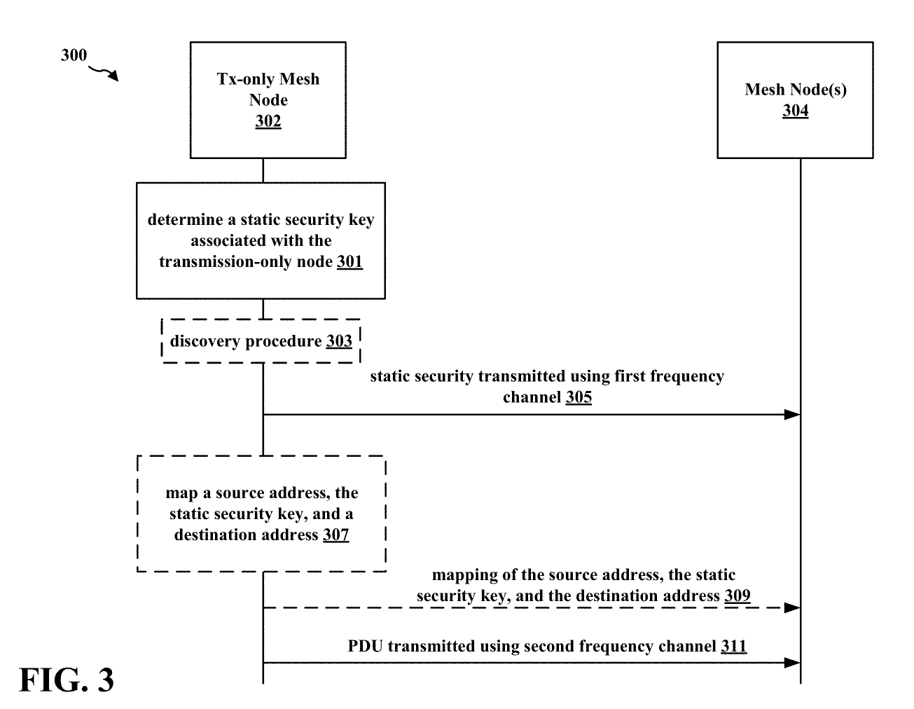

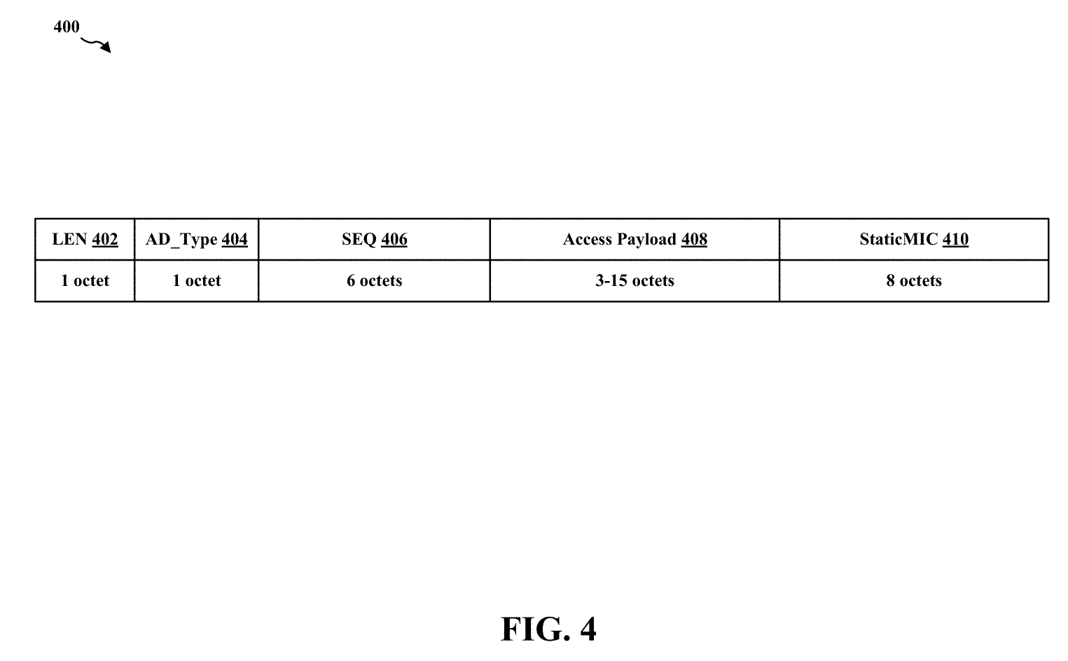

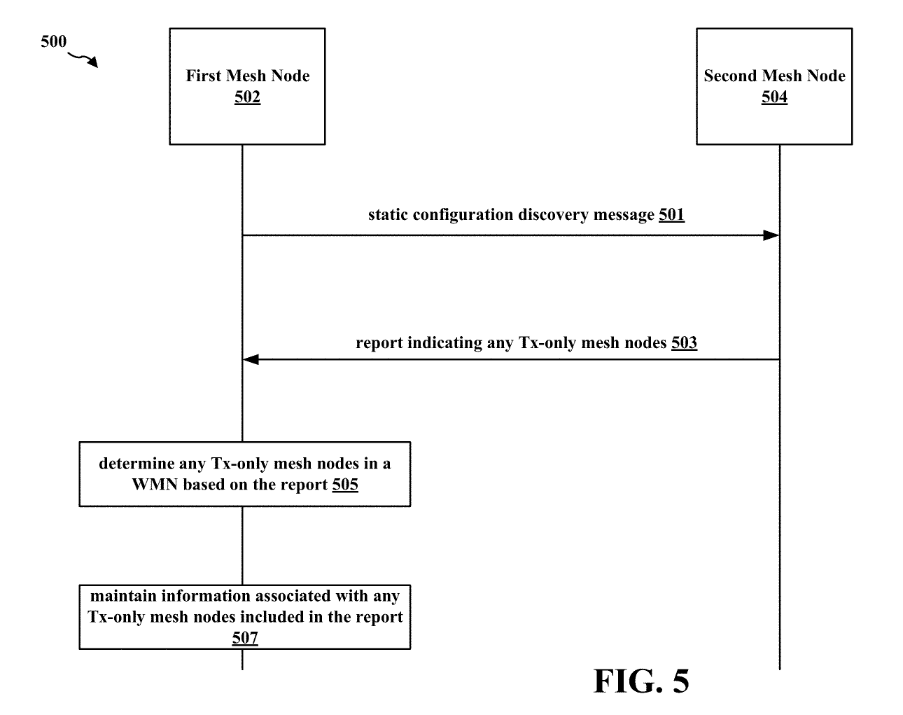

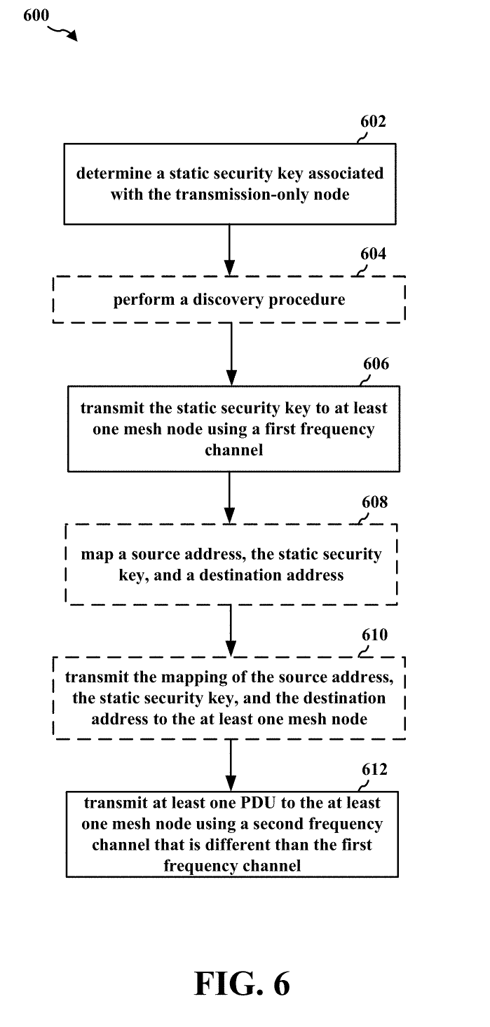

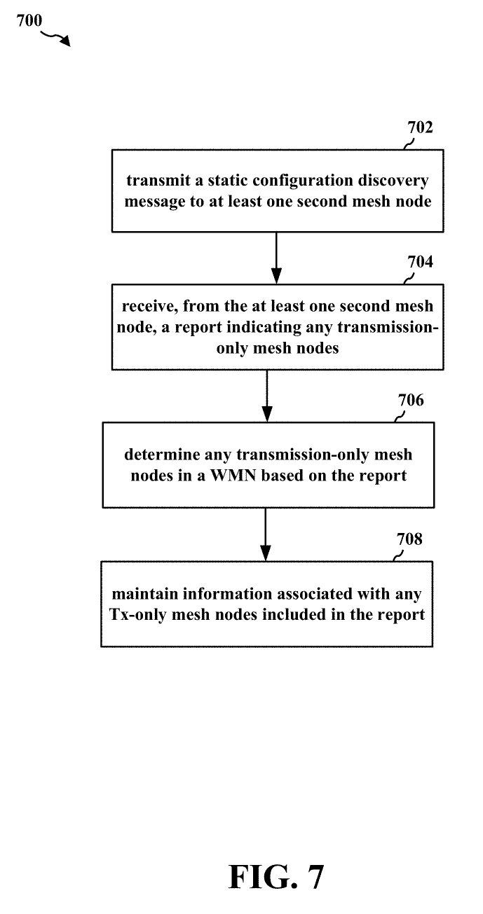

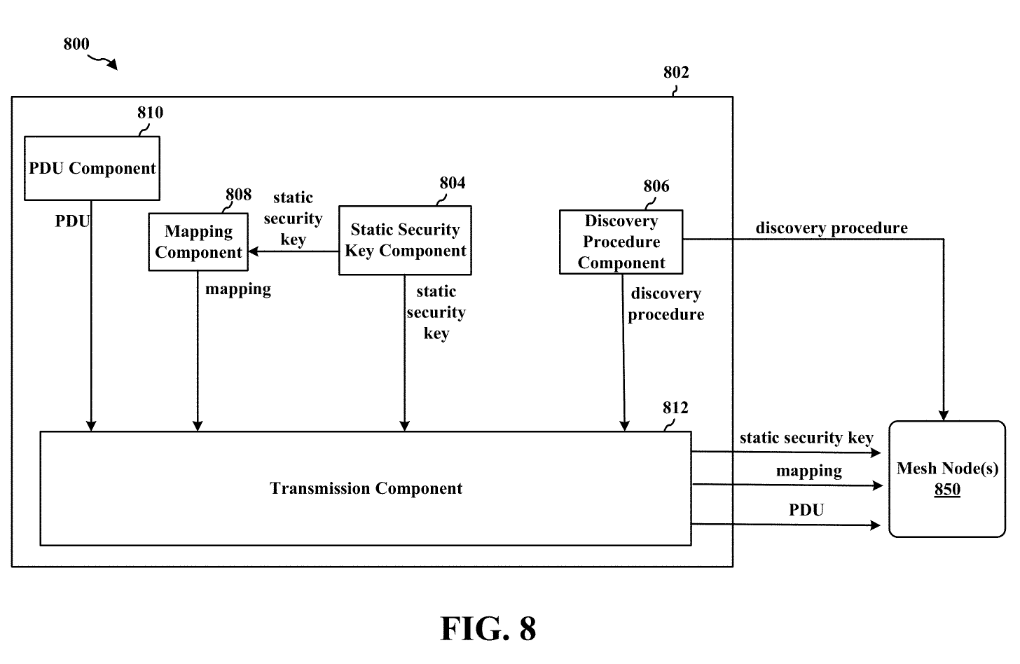

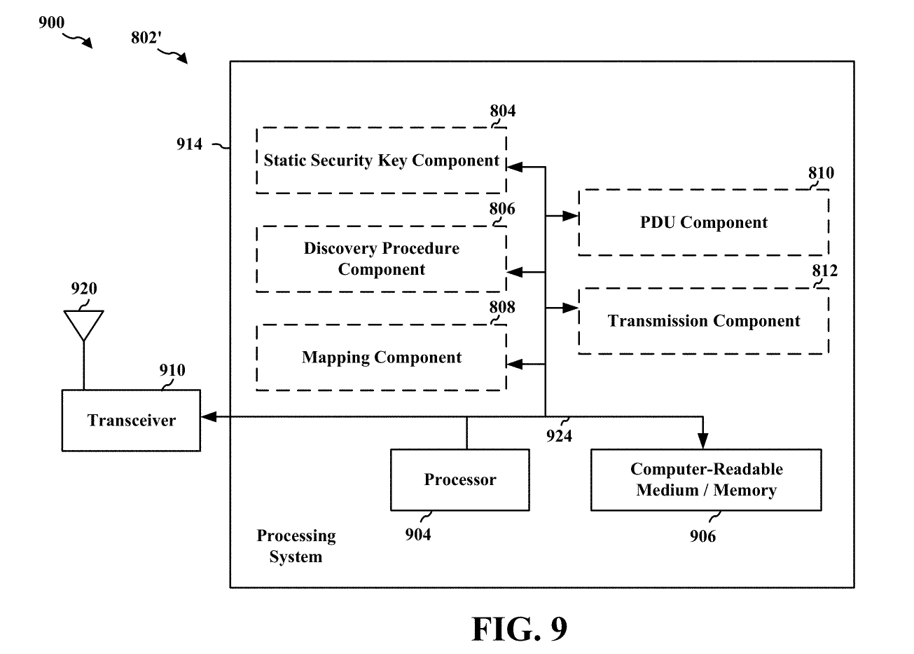

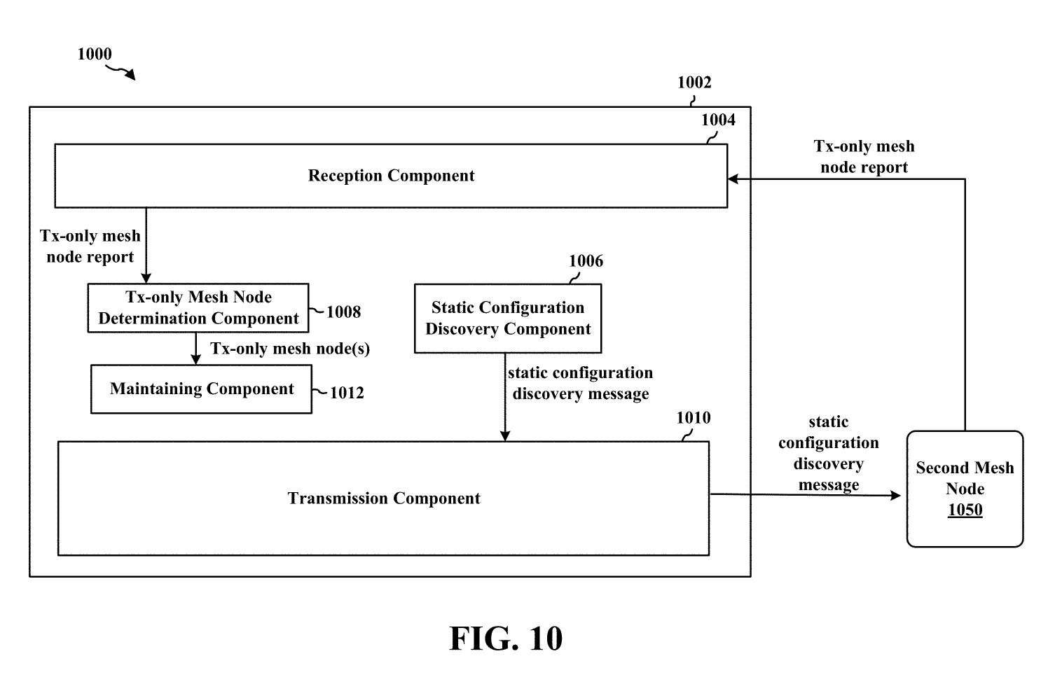

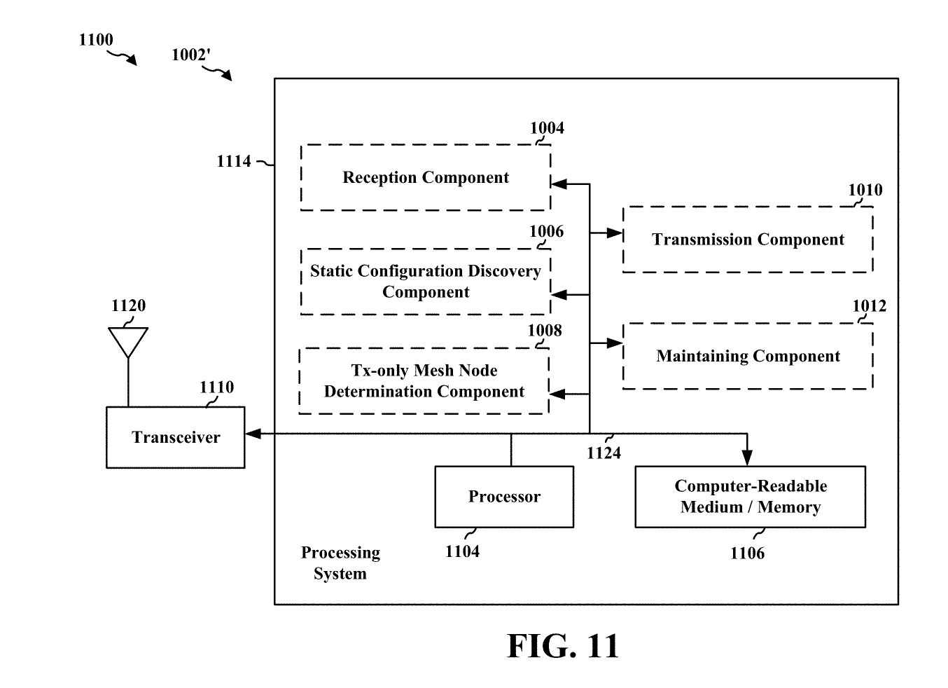

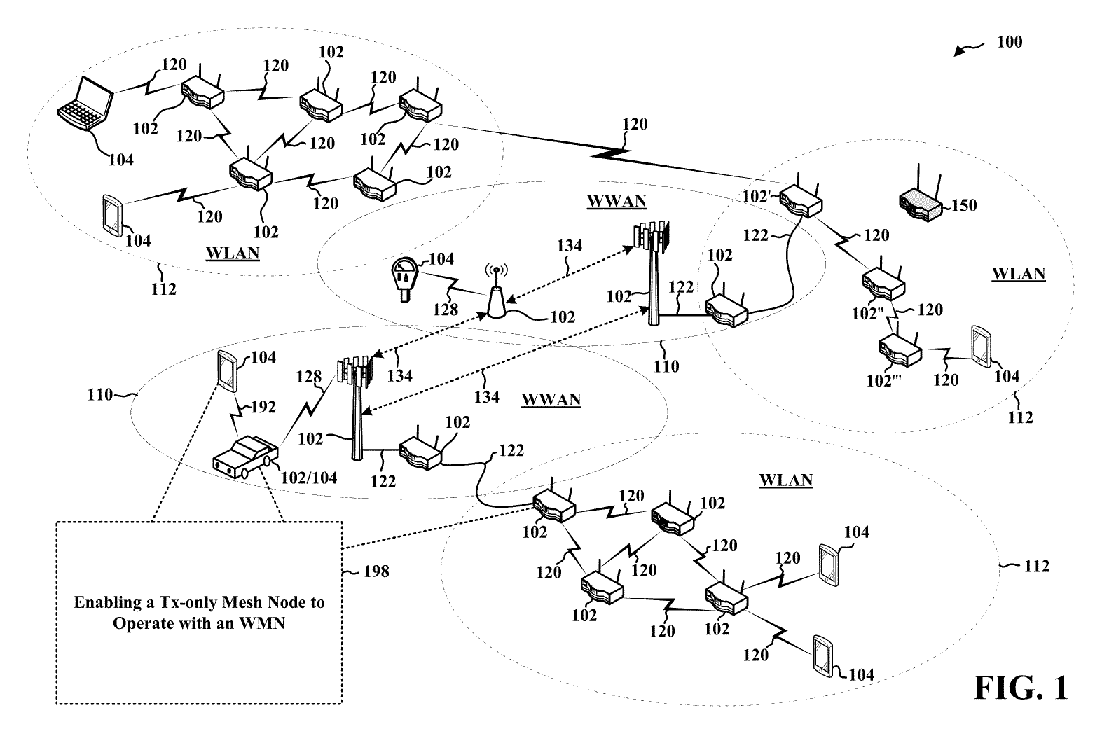

FIG. 1 illustrates an example WMN 100 in accordance with certain aspects of the disclosure. The WMN 100 may include one or more wireless wide area networks (WWANs) 110 and/or one or more wireless local area networks (WLANs) 112 that communicate with one another. Each WWAN 110 and WLAN 112 in the WMN 100 may include mesh nodes 102 that receive, transmit, relay, repeat, boost, etc., signals other mesh node(s) 102, and/or to mesh client devices 104. Each mesh node 102 may include a transmitter chain and a receiver chain, each of which may in turn include a plurality of components associated with signal transmission and reception (e.g., processors, modulators, multiplexers, demodulators, demultiplexers, antennas, etc.), as will be appreciated by one skilled in the art.

Examples of a mesh node 102 include a Tx-only mesh node, a base station, a g Node B (gNB) (e.g., a base station configured to operate in millimeter wave (mmW) frequencies and/or near mmW frequencies), a Node B, an evolved Node B (eNB), a Wi-Fi access point (AP), a base transceiver station, a radio base station, a radio transceiver, a transceiver function, a basic service set (BSS), an extended service set (ESS), a satellite, a satellite radio, a vehicle, a smart device, or some other similarly functioning devices. Certain mesh nodes 102 function as an access point to the WMN 100 for mesh client devices 104. Mesh nodes 102 may communicate with one another via a wireless communication link 120, a wired communication link 122, and/or through an evolved packet core (EPC) using a backhaul link 134.

Mesh client devices 104 may be either fixed or mobile, and dispersed throughout the WMN 100. Examples of mesh client devices 104 include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similarly functioning device. Some of the mesh client devices 104 may be referred to as Internet of Things (IoT) devices (e.g., parking meter, gas pump, toaster, vehicles, etc.). A mesh client device 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. Certain devices 102/104 in the WMN 100 may act as both a mesh node 102 (e.g., relaying signals from another mesh client device 104 to another mesh node 102) and a mesh client device 104.

Each mesh client device 104 may communicate with zero, one, or multiple mesh nodes 102 at any given moment. Each mesh node 102 may communicate with zero, one, or multiple mesh client devices 104 at any given moment. Each mesh node 102 may communicate with zero, one, or multiple other mesh nodes 102 at any given moment.

When a cellular base station (e.g., gNB, eNB, etc.) is used as a mesh node 102, the communication link(s) 128 between the mesh node 102 and the mesh client device 104 may include uplink (UL) transmissions transmitted from a mesh client device 104 to a mesh node 102 and/or downlink (DL) transmissions transmitted from a mesh node 102 to a mesh client device 104. The communication link 128 may use multiple-input and multiple-output (MIMO) antenna technology, including spatial multiplexing, beamforming, and/or transmit diversity. The communication link 128 may be through one or more carriers. The mesh node 102/mesh client device(s) 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (S Cell).

When a Wi-Fi router and/or a Wi-Fi AP is used as a mesh node 102, communications between different mesh nodes 102 or between a mesh node 102 and a mesh client device 104 may occur via a wireless communication link 120 in a 5 GHz unlicensed spectrum. When communicating in an unlicensed frequency spectrum, the mesh nodes 102/mesh client devices 104 may perform a clear channel assessment (CCA) prior to communicating in order to determine whether the channel is available.

Mesh client devices 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth®, ZigBee®, Wi-Fi based on the IEEE 802.11 standard, LTE, or NR.

According to certain aspects, the WMN 100 may support multi-hop communications in which a first mesh node 102′ utilizes a second mesh node 102″ as a relay to a third mesh node 102′″ (e.g., or a mesh client device 104). For instance, first mesh node 102′ may lack sufficient signal strength to transmit to third mesh node 102′″, but have sufficient signal strength to transmit to the second mesh node 102″. In addition, first mesh node 102′ may determine that second mesh node 102″ has sufficient signal strength to transmit to third mesh node 102′″. Here, first mesh node 102′ may route a DL communication through second mesh node 102″ to third mesh node 102′″. Hence, the second mesh node 102″ acts as a relay for the first mesh node 102′.

According to certain other aspects, the WMN 100 may be able to “self-form” and/or “self-heal” when a mesh node 150 within the WMN 100 malfunctions or is no longer a part of the mesh topology. For example, if the third mesh node 102′″ routes UL communications from a mesh client device 104 to the first mesh node 102′ via mesh node 150, the third mesh node 102′″ may route UL communications to the first mesh node 102′ via the second mesh node 102″ if mesh node 150 malfunctions. In other words, an updated topology that no longer includes mesh node 150 may be determined by the WMN 100 in order to continue relaying communications between the third mesh node 102′″ and the first mesh node′.

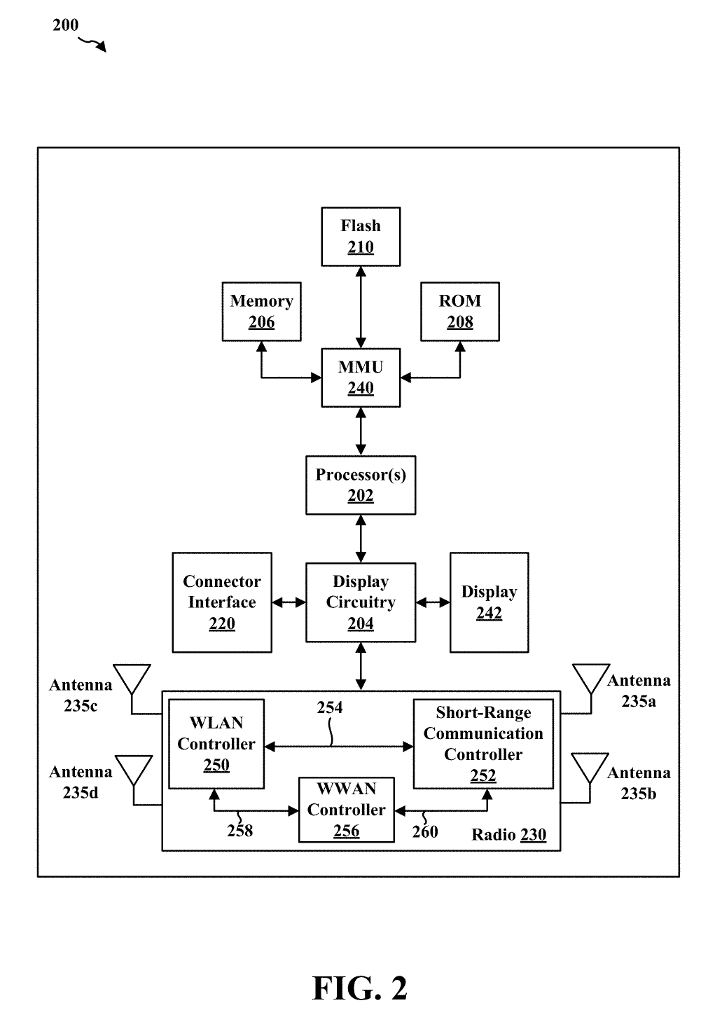

Referring again to FIG. 1, in certain aspects, the mesh node 102 may be a Tx-only mesh node configured to operate in the WMN and/or a mesh node that is configured to enable a Tx-only mesh node for operation within the WMN (198), e.g., as described in connection with any of FIGS. 2-11.

FIG. 2 is block diagram of a wireless device 200 in accordance with certain aspects of the disclosure. The wireless device 200 may correspond to, e.g., one of the wireless mesh nodes 102, and/or one of the wireless mesh client devices 104 in FIG. 1. In certain configurations, the wireless device 200 may be, e.g., a Tx-only mesh node and/or a mesh node that is configured to enable a Tx-only mesh node for operation within the WMN.

As shown in FIG. 2, the wireless device 200 may include a processing element, such as processor(s) 202, which may execute program instructions for the wireless device 200. The wireless device 200 may also include display circuitry 204 which may perform graphics processing and provide display signals to the display 242. The processor(s) 202 may also be coupled to memory management unit (MMU) 240, which may be configured to receive addresses from the processor(s) 202 and translate the addresses to address locations in memory (e.g., memory 206, ROM 208, Flash memory 210) and/or to address locations in other circuits or devices, such as the display circuitry 204, radio 230, connector interface 220, and/or display 242. The MMU 240 may be configured to perform memory protection and page table translation or set up. In some embodiments, the MMU 240 may be included as a portion of the processor(s) 202.

As shown, the processor(s) 202 may be coupled to various other circuits of the wireless device 200. For example, the wireless device 200 may include various types of memory, a connector interface 220 (e.g., for coupling to the computer system), the display 242, and wireless communication circuitry (e.g., for Wi-Fi, Bluetooth®, Bluetooth Low-Energy® (BLE), etc.). The wireless device 200 may include a plurality of antennas 235a, 235b, 235c, 235d, for performing wireless communication with, e.g., wireless devices in a WMN.

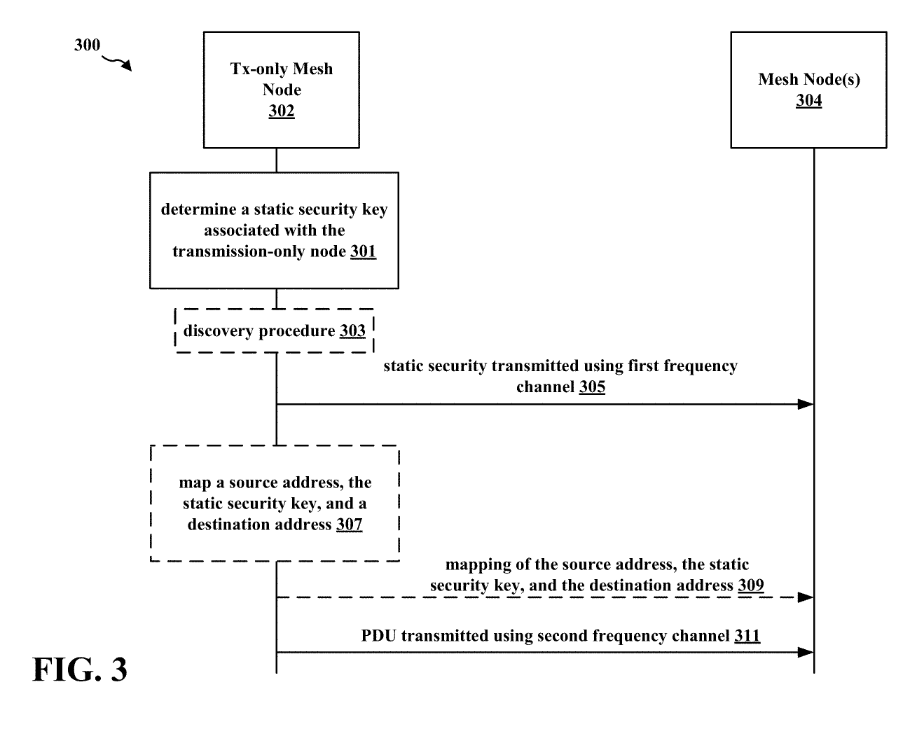

In certain aspects, the wireless device 200 may include hardware and software components (a processing element) configured to enable a Tx-only mesh node for operation within a WMN, e.g., using the techniques described below with reference to FIGS. 3-11. The wireless device 200 may also comprise wireless mesh firmware or other hardware/software for controlling wireless mesh operations. In addition, the wireless device 200 may store and execute a WLAN software driver for controlling WLAN operations, a short-range communication software driver for controlling short-range communication operations, and/or a WWAN software driver for controlling WWAN operations.

The wireless device 200 may be configured to implement part or all of the techniques described below with reference to FIGS. 3-11, e.g., by executing program instructions stored on a memory medium (e.g., a non-transitory computer-readable memory medium) and/or through hardware or firmware operation. In other embodiments, the techniques described below with reference to FIGS. 3-11 may be at least partially implemented by a programmable hardware element, such as an field programmable gate array (FPGA), and/or an application specific integrated circuit (ASIC).

In certain aspects, radio 230 may include separate controllers configured to control communications for various respective radio access technology (RAT) protocols. For example, as shown in FIG. 2, radio 230 may include a WLAN controller 250 configured to control WLAN communications, a short-range communications controller 252 configured to control short-range communications, and a WWAN controller 256 configured to control WWAN communications.

In certain implementations, a first coexistence interface 254 (e.g., a wired interface) may be used for sending information between the WLAN controller 250 and the short-range communications controller 252. In certain other implementations, a second coexistence interface 258 may be used for sending information between the WLAN controller 250 and the WWAN controller 256. In certain other implementations, a third coexistence interface 260 may be used for sending information between the short-range communications controller 252 and the WWAN controller 256.

In some aspects, one or more of the WLAN controller 250, the short-range communications controller 252, and/or the WWAN controller 256 may be implemented as hardware, software, firmware or some combination thereof.

In certain configurations, the WLAN controller 250 may be configured to communicate with a second device in a WMN using a WLAN link using all of the antennas 235a, 235b, 235c, 235d. In certain other configurations, the short-range communications controller 252 may be configured to communicate with at least one second device in a WMN using one or more of the antennas 235a, 235b, 235c, 235d. In certain other configurations, the WWAN controller 256 may be configured to communicate with a second device in a WMN using all of the antennas 235a, 235b, 235c, 235d. The WLAN controller, short-range communications controller 252, and/or the WWAN controller 256 may be configured to configured to enable a Tx-only mesh node (e.g., wireless device 200 or a remote device in a WMN) for operation within the WMN.

In order to be included in a WMN, a low-power mesh node (e.g., a Tx-only mesh node) may need to 1) be provisioned by a provisioning entity such as another mesh node (e.g., provisioning may be accomplished using a receiver at the low-power mesh node that may use a 100% duty cycle), 2) establish a friendship and/or connection with one or more other mesh nodes in the WMN (e.g., establishing a friendship and/or connection may use a 100% duty cycle), 3) maintain the friendship and/or connection with the one or more mesh nodes in the WMN (e.g., maintaining a friendship and/or connection may use a 0.5% duty cycle), and/or 4) remain up to date with security updates associated with communications within the WMN (e.g., remaining up to date with security updates, such as security key updates, may use a 0.5% duty cycle). Each of 1), 2), 3), and 4) listed above may be implemented using a receiver at a mesh node, and the receiver may use power to listen for packets from other mesh nodes within the WMN.

One way of reducing the power consumption of a mesh node is to configure a mesh node as a Tx-only mesh node. Mesh nodes that include both a transmitter and receiver may have to exit a low-power state to both transmit protocol data units (PDUs) and to monitor for PDUs being sent from other mesh nodes. By excluding a receiver, a Tx-only mesh node may exit a low-power state (e.g., and enter an active power state) to transmit PDUs but not to monitor for PDUs sent from other mesh nodes. Hence, the amount of time the Tx-only mesh nodes in an active power state may be reduced, and thus, the power consumption of a Tx-only mesh node may also be reduced as compared to a mesh node that includes both a transmitter and receiver.

Another way of reducing power consumption of a mesh node is to reduce the transmission of time of a PDU. The transmission time of a PDU may be reduced by omitting certain information. In certain scenarios, a PDU may include one or more security keys, a data payload, a source address of the transmitting device, and a destination address of the device for which the PDU is intended. By omitting certain information from the PDU (e.g., such as the source address and the destination address), the power consumption of a Tx-only mesh node may be further reduced.

Traditional Tx-only mesh nodes may not be included in a WMN for various reasons. For example, since a Tx-only mesh node does not include a receiver, it may not be possible for Tx-only mesh nodes to be provisioned by a provisioning entity, to perform security key updates and/or IV key updates, and/or to bind to application keys or network keys. In order to indicate the source of the PDU and the intended destination of the PDU, traditional Tx-only mesh nodes may include a source address and the destination address in a transmitted PDU.

Thus, there is a need to provide a Tx-only mesh node that is configured to operate in a WMN using reduced power consumption as compared to traditional Tx-only mesh nodes. In addition, there is a need to provide a Tx-only mesh node that is configured to operate in a WMN without being provisioned by a provisioning entity, performing security key updates, binding to application keys or network keys.

The present disclosure provides a solution by configuring a Tx-only mesh node for use in a WMN. For example, the solution may include configuring the Tx-only mesh node to determine a static security key (e.g., static shared secret) that a provisioning entity (e.g., another mesh node) may receive in an out of band frequency channel (e.g., a different frequency channel than a frequency channel used to transmit a PDU), to use a sufficiently long sequence number (SEQ) (e.g., a 48-bit SEQ that does not repeat for x number of years when PDUs are sent every y milliseconds (ms)) in transmissions to other mesh nodes in order to forego the use of updated security keys and/or updated IV keys, and to configure the static security key to be different than the NetKey and/or AppKey used for secure message exchange within the WMN without using a DevKey. Because a Tx-only mesh node may not be able to bind to a NetKey, AppKey, and/or DevKey, it may be beneficial to use a static security key to encrypt communications sent from the Tx-only mesh node.

FIG. 3 illustrates a data flow 300 for communications between a Tx-only mesh node 302 and one or more other mesh nodes 304 in a WMN in accordance with certain aspects of the disclosure. Tx-only mesh node 302 may correspond to, e.g., mesh node 102, the apparatus 802/802′. The one or more mesh nodes 304 may correspond to, e.g., mesh node 102, 850, 1050, first mesh node 502, second mesh node 504, the apparatus 1002/1002′. The Tx-only mesh node 302 and the one or more mesh nodes 304 may be configured to communicate using cellular communications. In certain configurations, the Tx-only mesh node 302 may be configured for short-range communications such as Wi-Fi communications, Bluetooth® communications, and/or Zigbee® communications. The Tx-only mesh node 302 may include a transmitter for transmitting PDUs to other mesh nodes and/or mesh client devices. However, the Tx-only mesh node 302 may not include a receiver in order to reduce power consumption, and hence, to extend battery life.

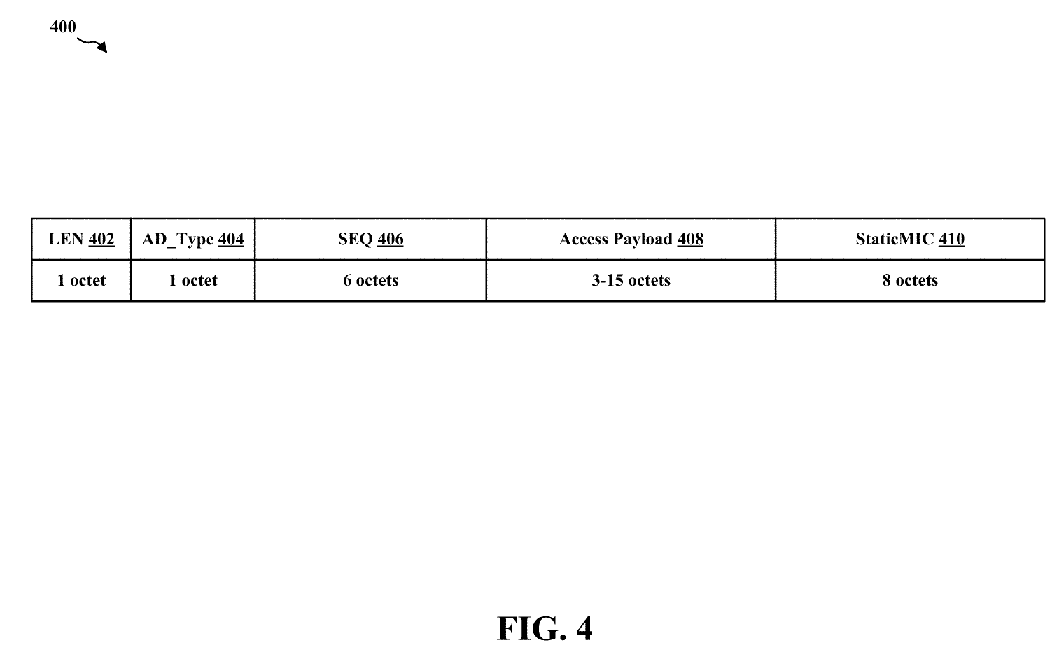

In certain implementations, the Tx-only mesh node 302 may determine 301 a static security key associated with the Tx-only mesh node 302. In one aspect, the static security key may include a MIC such as a 8-bit, 16-bit, 32-bit, or 64-bit MIC that may be used by the one or more mesh nodes 304 to authenticate a transmission received from the Tx-only mesh node 302. Data authentication may be used to ensure that data (e.g., an access payload) does not change during transmission from the Tx-only mesh node 302 to the one or more mesh nodes 304. In order to determine if a received transmission includes data that changed during transmission, the Tx-only mesh node 302 may include the MIC in a StaticPDU (e.g., see FIG. 4).

In certain other implementations, the Tx-only mesh node 302 may perform a discovery procedure 303 with the one or more mesh nodes 304 to establish a connection therewith. During the discovery procedure, the Tx-only mesh node 302 may transmit the static security key 305 (e.g., including the MIC) to the one or more mesh nodes 304 (e.g., a provisioning mesh node) using a first frequency channel (e.g., an out-of-band frequency channel). An out-of-band frequency channel may include a frequency band that is only used for sending that initial indication of the static security key to receiving nodes.

In one aspect, the discovery procedure 303 may include one of a near-field communication (NFC) protocol or discovery based on a quick response (QR) code. NFC may occur when the Tx-only mesh node 302 is positioned (e.g., by a user) within a predetermined distance of the one or more mesh nodes 304, and when a user interacts with a NFC initiator (e.g., button, touch sensitive region, etc.) located on the Tx-only mesh node 302, e.g., to initiate the discovery procedure. Discovery based on a QR code may include capturing an image of a QR code located on an exterior of the one or more mesh nodes 304 using a camera located at the Tx-only mesh node 302, or vice versa.

In certain other implementations, the Tx-only mesh node 302 may map 307 one or more of a source address (e.g., a Bluetooth® address of the Tx-only mesh node 302), the static security key, a destination address (e.g., an intended destination mesh node and/or mesh client device for all PDU transmissions), and/or an AppKey (e.g., the AppKey may be used to secure the WMN). The Tx-only mesh node 302 may transmit (e.g., broadcast and/or publish) a mapping 309 of the source address, the static security key, and/or the destination address to the one or more mesh nodes 304. In certain implementations, the destination address may be included in the mapping 309 when PDUs sent by the Tx-only mesh node 302 are intended for the same destination mesh node and/or mesh client device (e.g., an unchanging destination mesh node and/or mesh client device).

For example, the mapping 309 may include a message indicating that PDUs may be received from Bluetooth device address (BD_ADDR) 00:02:5bff:0b:04 (e.g., source address of the Tx-only mesh node 302) that will be secured with the static security key «X», and that the one or more mesh nodes 304 should relay PDUs secured using the AppKey key index and/or static security key to the given destination address (e.g., the destination mesh node and/or mesh client device). In certain configurations, the security key «X» may be a random number that is generated at the point of manufacture, or at the point when the Tx-only mesh node was first powered on (e.g. when a plastic pull-tab is removed from the mesh node by a user before installation in the WMN), or manually configured during configuration at the point of sale or at the point of installation. The mapping 309 may be transmitted using the first frequency channel used to transmit the static security key or a different second frequency channel used to transmit data PDUs (e.g., PDUs that do not initially convey the static security key to receiving nodes).

The Tx-only mesh node 302 may transmit at least one PDU 311 to the one or more mesh nodes 304 using a second frequency channel that is different than the first frequency channel. For example, the second frequency channel may be an in-band frequency channel that is used for communication of data PDUs within the WMN. When the mapping 309 is sent to the one or more mesh nodes 304, the PDU 311 may not include the source address and/or the destination address, since the mapping 309 already communicated such information.

In certain implementations, the PDU 311 may include a first section that indicates a length of the PDU (e.g., see 402 in FIG. 4), a second section that indicates an advertisement data type (e.g., see 404 in FIG. 4), a third section that indicates a sequence number associated with the Tx-only mesh node 302 (e.g., see 406 in FIG. 4), a fourth section that includes an access payload (e.g., see 408 in FIG. 4), and a fifth section that includes the static security key (e.g., see 410 in FIG. 4).

In certain configurations, the one or more mesh nodes 304 may compare a MIC included in a received PDU 311 to the MIC of the static security key 305 to determine if the data changed during transmission from the Tx-only mesh node 302 to the one or more mesh nodes 304. If the one or more mesh nodes 304 determine that the MIC included in the PDU 311 is the same as the MIC of the static security key 305, the one or more mesh nodes 304 may determine that the data in the PDU 311 did not change during transit. If it is determined that the data in the PDU 311 did not change during transit, the one or more mesh nodes 304 may relay the PDU 311 to the destination node/destination client device.

If the one or more mesh nodes 304 determine that the MIC included in the PDU 311 is different than the MIC of the static security key 305, the one or more mesh nodes 304 may determine that the data in the PDU 311 did change during transit. The one or more mesh nodes 304 may attempt to correct any errors in the PDU 311, and relay the PDU 311 to the destination node/destination client device when the errors are correctable. Otherwise, the one or more mesh nodes 304 may discard the PDU 311, and wait for a subsequent transmission of the PDU 311 from the Tx-only mesh node 302.

Using the techniques described above in connection with FIG. 3, a Tx-only mesh node of the present disclosure may operate in a WMN using reduced power consumption as compared to traditional Tx-only mesh nodes by omitting a receiver, and by omitting a source address and a destination address from data PDUs. In addition, Tx-only mesh node of the present disclosure may be configured to in a WMN without being provisioned by a provisioning entity, performing security key updates, binding to application keys or network keys.

FIG. 4 is a diagram illustrating a PDU frame structure 400 (e.g., a StaticPDU frame structure) that may be transmitted by a Tx-only mesh node (e.g., such as Tx-only mesh node 302 in FIG. 3) to one or more mesh nodes (e.g., such as one or more mesh nodes 304 in FIG. 3) in a WMN in accordance with certain aspects of the disclosure.

For example, the PDU frame structure 400 may include a first section 402 that includes one octet (e.g., eight bits) and indicates a length (LEN) of the PDU, a second section 404 that includes one octet and indicates an advertisement data type (AD_Type), a third section 406 that includes six octets and indicates a sequence number (e.g., SEQ) associated with the Tx-only mesh node, a fourth section 408 that includes three to fifteen octets of an access payload, and a fifth section 410 that includes eight octets and that indicates the StaticMIC (e.g., the static security key). In certain configurations, the AD_Type may indicate transmission power, a device name, or a list of services that a Tx-only mesh node supports, just to name a few. In certain implementations, the SEQ 406 may be obfuscated by contents of the access payload and/or StaticMlC 410. The obfuscation of messages may be used to protect the privacy of a user, and may require obfuscation entropy. In WMNs, such as a BT WMN, obfuscation entropy may come from the sequence number and source address along with parts of the PDU that are already encrypted, and hence, random. In a Tx-only mesh node, the obfuscation entropy may be achieved using an encrypted access payload.

In certain other implementations, the access payload may be unchanged, but may have restrictions. An access payload may include, e.g., a sensor reading, such as the room temperature, and hence the access payload would not be changed in order convey specific information.

In certain other implementations, unacknowledged messages may be sent. For example, unacknowledged messages associated with sensor status and/or unreliability associated with a generic on/off setting. In WMNs, acknowledged messages that elicit a response from a receiving mesh node, or an unacknowledged messages that do not elicit a response from a receiving mesh node may be transmitted by mesh nodes. Because a Tx-only mesh node is unable to receive messages, a Tx-only mesh node may be able to send unacknowledged messages but not acknowledged messages.

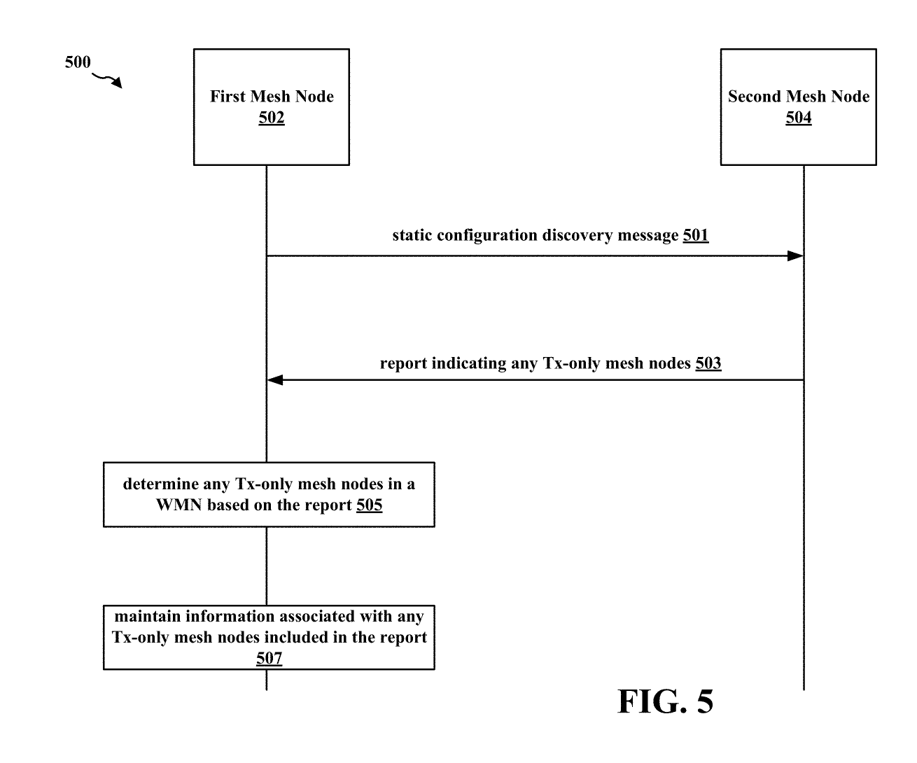

FIG. 5 illustrates a data flow 500 between a first mesh node 502 and a second mesh node 504 in a WMN in accordance with certain aspects of the disclosure. The first mesh node 502 may correspond to, e.g., mesh node 102, 304, 850, the apparatus 1002/1002′. The second mesh node 504 may correspond to, e.g., mesh node 102, 304, 850, second mesh node 1050. In certain aspects, the second mesh node 504 may include more than one mesh node.

In certain implementations, the first mesh node 502 may transmit a static configuration discovery message 501 to the second mesh node 504. In certain configurations, the static configuration discovery message 501 may include a request for a report indicating any Tx-only mesh nodes that are in communication with or in range of (e.g., detectable by) the second mesh node 504. For example, the report may indicate any Tx-only mesh nodes that have performed a discovery procedure (e.g., the discovery procedure 303 discussed supra with respect to FIG. 3) with the second mesh node 504 and/or that are in range of the second mesh node 504.

In certain implementations, the second mesh node 504 send the “BD_ADDR” (e.g., source address) of any Tx-mesh node(s) in a report 503 to the first mesh node 502 if the second mesh node 504 is aware of any static Tx-only mesh nodes.

In certain other implementations, the first mesh node 502 may receive, from the second mesh node 504, the report 503 indicating any Tx-only mesh nodes that are in communication with or in range of the second mesh node 504. In one aspect, the report 503 may include one or more of any source addresses, static security keys, and/or destination addresses of any Tx-only mesh nodes within range of the second mesh node 504 (e.g., the mapping 309 of the source address, the static security key, and/or the destination address transmitted to the more mesh nodes 304 in FIG. 3).

In certain other implementations, the first mesh node 502 may determine 505 any Tx-only mesh nodes in a WMN based on the report. The first mesh node 502 may maintain 507 (e.g., in a look-up table) a respective mapping of the source address, static security key, and/or the destination address associated with each Tx-only included in the report 503.

When the first mesh node 502 receives a PDU that originates from a Tx-only mesh node (e.g., not shown in FIG. 5), the first mesh node 502 may determine a source address and/or destination address associated with the PDU based on a comparison of the static security key included in the PDU. The first mesh node 502 may relay the PDU to the destination mesh node using information associated with a mesh topology and the destination address.

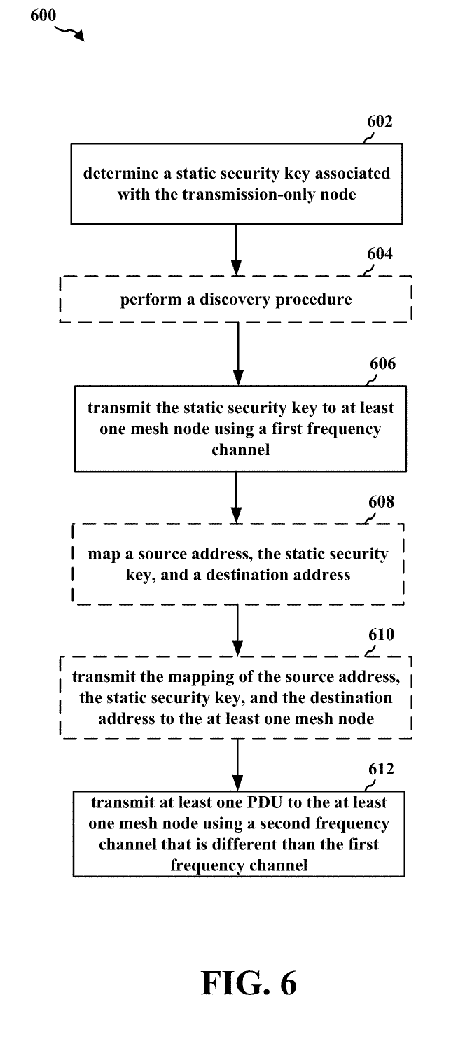

FIG. 6 is a flowchart 600 of a method of wireless communication. The method may be performed by a Tx-only node (e.g., mesh node 102, Tx-only mesh node 302, the apparatus 802/802′) in communication with one or more mesh nodes (e.g., mesh node 102, 304, 850, 1050, the apparatus 1002/1002′). In FIG. 6, optional operations are indicated with dashed lines

At 602, the Tx-only node may determine a static security key associated with the Tx-only mesh node. In one aspect, the static security key may include a MIC. For example, referring to FIG. 3, the Tx-only mesh node 302 may determine 301 a static security key associated with the Tx-only mesh node. In one aspect, the static security key may include a MIC such as a 8-bit, 16-bit, 32-bit, or 64-bit MIC that may be used by the one or more mesh nodes 304 in authenticating a transmission sent by the Tx-only mesh node 302. Data authentication may be used to ensure that data (e.g., an access payload) is not changed during transit from the Tx-only mesh node 302 to the one or more mesh nodes 304. In order to determine if a received transmission includes data that changed during transmission, the Tx-only mesh node 302 may include a MIC in a StaticPDU.

At 604, the Tx-only node may perform a discovery procedure to establish a connection with the at least one mesh node. In one aspect, the discovery procedure includes one of a NFC protocol or discovery based on a QR code. For example, referring to FIG. 3, the Tx-only mesh node 302 may perform a discovery procedure 303 with the one or more mesh nodes 304 to establish a connection therewith. In one aspect, the discovery procedure 303 may include one of a NFC protocol or discovery based on a QR code. NFC may occur when the Tx-only mesh node 302 is positioned (e.g., by a user) within a predetermined distance of the one or more mesh nodes 304, and when a user interacts with a NFC initiator (e.g., button, touch sensitive region, etc.) located on the Tx-only mesh node 302. Discovery based on a QR code may include capturing an image of a QR code located on an exterior of the one or more mesh nodes 304 using a camera located at the Tx-only mesh node 302, or vice versa.

At 606, the Tx-only node may transmit the static security key to at least one mesh node using a first frequency channel. In one aspect, the static security key may be transmitted to the at least one mesh node using the first frequency channel during the discovery procedure. For example, referring to FIG. 3, the Tx-only mesh node 302 may transmit the static security key 305 (e.g., including the MIC) to the one or more mesh nodes 304 (e.g., a provisioning mesh node) using a first frequency channel (e.g., an out-of-band frequency channel). In certain configurations, the static security key 305 may be transmitted during the discovery procedure 604. In certain other configurations, the static security key 305 may be transmitted after the discovery procedure 304. An out-of-band frequency channel may include a frequency band that is not used for sending PDUs within the WMN. In certain implementations, the static security key may be transmitted before or after the discovery procedure 303.

At 608, the Tx-only node may map a source address, the static security key, and a destination address. For example, referring to FIG. 3, the Tx-only mesh node 302 may map 307 one or more of a source address (e.g., a Bluetooth® address of the Tx-only mesh node 302), the static security key, a destination address (e.g., an intended destination mesh node and/or mesh client device for all PDU transmissions), and/or an AppKey. In certain implementations, the destination address may be included in the mapping 309 when PDUs that will be sent by the Tx-only mesh node 302 are intended for the same destination mesh node and/or mesh client device (e.g., an unchanging destination mesh node and/or mesh client device). For example, the mapping 309 may include a message indicating that PDUs may be received from BD_ADDR 00:02:5bff:0b:04 (e.g., source address of the Tx-only mesh node 302) that will be secured with the static key «X» (e.g., static security key), and that the one or more mesh nodes 304 should relay PDUs secured using the AppKey key index and/or static security key to the given destination address (e.g., the destination mesh node and/or mesh client device).

At 610, the Tx-only node may transmit the mapping of the source address, the static security key, and the destination address to the at least one mesh node. For example, referring to FIG. 3, the Tx-only mesh node 302 may transmit (e.g., broadcast and/or publish) a mapping 309 of the source address, the static security key, and/or the destination address to the one or more mesh nodes 304. In certain implementations, the destination address may be included in the mapping 309 when PDUs sent by the Tx-only mesh node 302 are intended for the same destination mesh node and/or mesh client device (e.g., an unchanging destination mesh node and/or mesh client device).

At 612, the Tx-only node may transmit at least one PDU to the at least one mesh node using a second frequency channel that is different than the first frequency channel. For example, the at least one PDU may be a data PDU that conveys sensor information (e.g., electricity usage, thermostat information, etc.) determined at the Tx-only mesh node 302. In one aspect, the PDU may include a sequence number associated with the Tx-only mesh node. In another aspect, the PDU may not include a source address or a destination address. In another aspect, the PDU may include a first section that indicates a length of the PDU, a second section that indicates an advertisement data type, a third section that indicates a sequence number, a fourth segment that includes a payload, and a fifth segment that includes the static security key. For example, referring to FIG. 3, the Tx-only mesh node 302 may transmit at least one PDU 311 to the one or more mesh nodes 304 using a second frequency channel that is different than the first frequency channel. For example, the second frequency channel may be an in-band frequency channel that is used for communication of PDUs within the WMN. When the mapping 309 is sent to the one or more mesh nodes 304, the PDU may not include the source address and/or the destination address, since the mapping 309 already communicated such information. In certain implementations, the PDU 311 may include a first section that indicates a length of the PDU (e.g., see 402 in FIG. 4), a second section that indicates an advertisement data type (e.g., see 404 in FIG. 4), a third section that indicates a sequence number associated with the Tx-only mesh node 302 (e.g., see 406 in FIG. 4), a fourth section that includes an access payload (e.g., see 408 in FIG. 4), and a fifth section that includes the static security key (e.g., see 410 in FIG. 4). The sequence number may be of sufficient length such that the sequence number does not repeat for x number of years when PDUs are sent every y milliseconds (ms). In certain implementations, x may be equal to 8925 and y may be equal to 1.

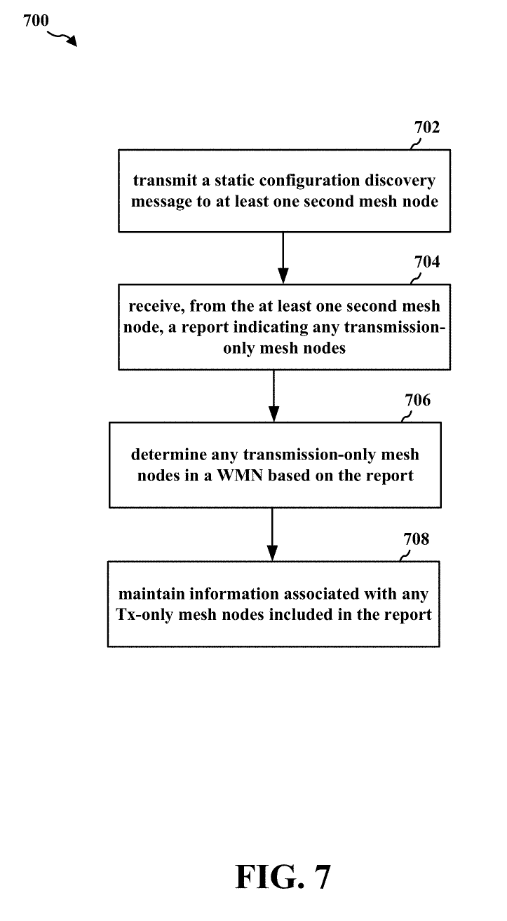

FIG. 7 is a flowchart 700 of a method of wireless communication. The method may be performed by a first mesh node (e.g., mesh node 102, 304, 850, the apparatus 1002/1002′, the first mesh node 502) in communication with a second mesh node (e.g., mesh node 102, 304, 850, 1050, the second mesh node 504).

At 702, the first mesh node may transmit a static configuration discovery message to at least one second mesh node. In one aspect, the static configuration discovery message may include a request for a report indicating any Tx-only mesh nodes. For example, referring to FIG. 5, the first mesh node 502 may transmit a static configuration discovery message 501 to the second mesh node 504. In certain configurations, the static configuration discovery message 501 may include a request for a report indicating any Tx-only mesh nodes that are in communication with or in range of (e.g., detectable) the second mesh node 504. For example, the report may indicate any Tx-only mesh nodes that have performed a discovery procedure (e.g., the discovery procedure 303 discussed supra with respect to FIG. 3) with the second mesh node 504 and/or that are in range of the second mesh node 504. In certain implementations, the static configuration discovery message 501 may request that if the second mesh node 504 is aware of any static Tx-only mesh nodes, the second mesh node 504 send the “BD_ADDR” (e.g., source address) of static Tx-mesh node(s) to the first mesh node 502.

At 704, the first mesh node may receive, from the at least one second mesh node, the report indicating any Tx-only mesh nodes. In one aspect, the report may include at least one source address associated with at least one Tx-only mesh node. For example, referring to FIG. 5, the first mesh node 502 may receive, from the second mesh node 504, the report 503 indicating any Tx-only mesh nodes that are in communication with or in range of the second mesh node 504. In one aspect, the report 503 may include one or more of any source addresses, static security keys, and/or destination addresses of any Tx-only mesh nodes within range of the second mesh node 504 (e.g., the mapping 309 of the source address, the static security key, and/or the destination address transmitted to the more mesh nodes 304 in FIG. 3).

At 706, the first device may determine any Tx-only mesh nodes in a WMN based on the report. For example, referring to FIG. 5, may determine 505 any Tx-only mesh nodes in a WMN based on the report.

At 708, the first device may maintain information associated with any Tx-only mesh nodes included in the report. For example, referring to FIG. 5, the first mesh node 502 may maintain 507 (e.g., in a look-up table) a respective mapping of the source address, static security key, and/or the destination address associated with each Tx-only included in the report 503.

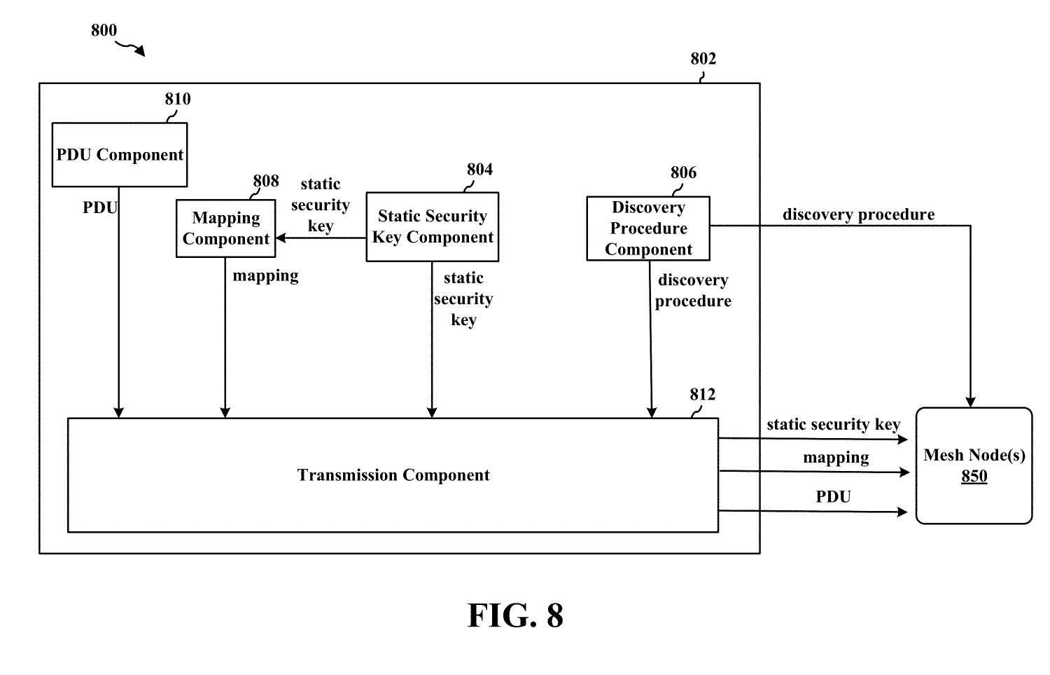

FIG. 8 is a conceptual data flow diagram 800 illustrating the data flow between different means/components in an exemplary apparatus 802. The apparatus may be a Tx-only mesh node (e.g., mesh node 102, Tx-only mesh node 302, the apparatus 802′) in communication with at least one mesh node 850 (e.g., mesh node 102, mesh node(s) 304, first mesh node 502, second mesh node 504, 1050, the apparatus 1002/1002′). The apparatus may include a static security key component 804, a discovery procedure component 806, a mapping component 808, a PDU component 810, and a transmission component 812.

In certain configurations, the static security key component 804 may be configured to determine a static security key associated with the Tx-only node (e.g., apparatus 802). In one aspect, the static security key may include a MIC. The static security key component 804 may be configured to send a signal associated with the static security key to one or more of the mapping component 808 and/or the transmission component 812.

In certain configurations, the discovery procedure component 806 may be configured to perform a discovery procedure to establish a connection with the at least one mesh node 850. In one aspect, the discovery procedure may include one of a NFC protocol or discovery based on a QR code. In certain other configurations, the discovery procedure component 806 may be configured to send a signal associated with the discovery procedure (e.g., indicating a discovered mesh node) to the transmission component 812.

In certain configurations, the transmission component 812 may be configured to transmit the static security key to at least one mesh node 850 using a first frequency channel.

In certain configurations, the mapping component 808 may be configured to map a source address (e.g., the BD_ADDR of the apparatus 802), the static security key, and a destination address (e.g., the BD_ADDR of the at least one mesh node 850). In certain aspects, the mapping component 808 may be configured to send a signal associated with the mapping of the source address, the static security key, and the destination address to the transmission component 812.

In certain configurations, the transmission component 812 may be configured to transmit the mapping of the source address, the static security key, and the destination address to the at least one mesh node 850. In certain configurations, the mapping may be transmitted using the first frequency channel used for transmitting the static security key. In certain other configurations, the mapping may be transmitted using a different second frequency channel used for transmitting PDUs.

In certain configurations, the PDU component 810 may be configured to generate a PDU for transmission to the at least one mesh node 850. In one aspect, the PDU may include a sequence number associated with the Tx-only mesh node. In another aspect, the PDU may not include a source address or a destination address. In another aspect, the PDU may include a first section that indicates a length of the PDU, a second section that indicates an advertisement data type, a third section that indicates a sequence number, a fourth segment that includes a payload, and a fifth segment that includes the static security key. In certain aspects, the PDU component 810 may be configured to send a signal associated with the PDU to the transmission component 812.

In certain configurations, the transmission component 812 may be configured to transmit at least one PDU to the at least one mesh node 850 using a second frequency channel that is different than the first frequency channel.

The apparatus may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

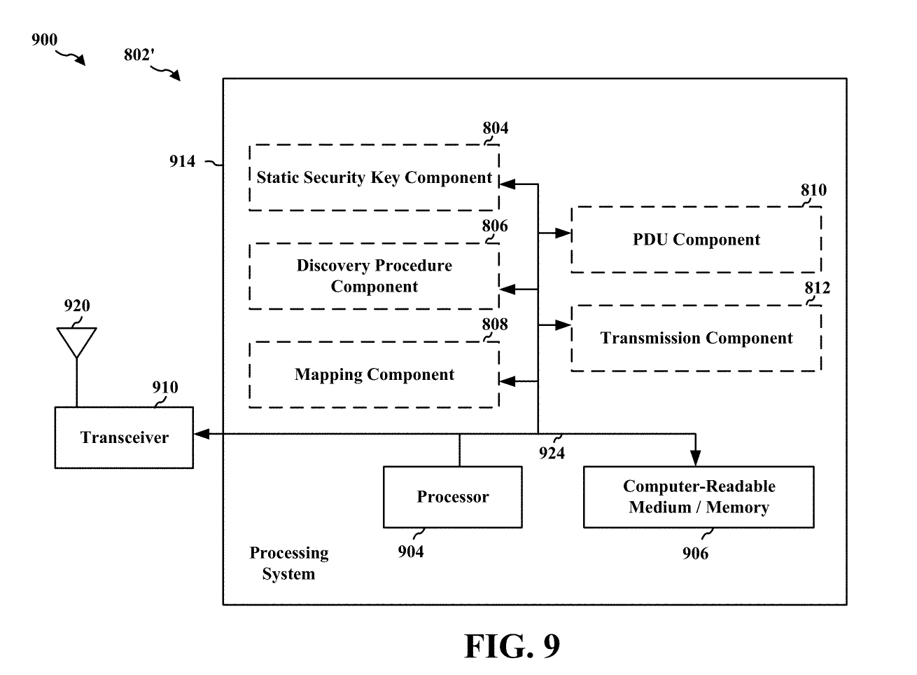

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 804, 806, 808, 810, 812, and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives information from the processing system 914, specifically the transmission component 812, and based on the received information, generates a signal to be applied to the one or more antennas 920. The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 804, 806, 808, 810, 812. The components may be software components running in the processor 904, resident/stored in the computer readable medium/memory 906, one or more hardware components coupled to the processor 904, or some combination thereof.

In certain configurations, the apparatus 802/802′ for wireless communication may include means for determining a static security key associated with the Tx-only mesh node. In one aspect, the static security key may include a MIC. In certain other configurations, the apparatus 802/802′ for wireless communication may include means for performing a discovery procedure to establish a connection with the at least one mesh node. In one aspect, the discovery procedure includes one of a NFC protocol or discovery based on a QR code. In certain other configurations, the apparatus 802/802′ for wireless communication may include means for transmitting the static security key to at least one mesh node using a first frequency channel. In one aspect, the static security key may be transmitted to the at least one mesh node using the first frequency channel during the discovery procedure. In certain other configurations, the apparatus 802/802′ for wireless communication may include means for mapping a source address, the static security key, and a destination address. In certain other configurations, the apparatus 802/802′ for wireless communication may include means for transmitting the mapping of the source address, the static security key, and the destination address to the at least one mesh node. In certain other configurations, the apparatus 802/802′ for wireless communication may include means for transmitting at least one PDU to the at least one mesh node using a second frequency channel that is different than the first frequency channel. In one aspect, the PDU may include a sequence number associated with the Tx-only mesh node. In another aspect, the PDU may not include a source address or a destination address. In other aspects, the PDU may include a first section that indicates a length of the PDU, a second section that indicates an advertisement data type, a third section that indicates a sequence number, a fourth segment that includes a payload, and a fifth segment that includes the static security key. The aforementioned means may be the processor(s) 202, the MMU 240, WLAN controller 250, short-range communications controller 252, the radio 230, one or more of the aforementioned components of the apparatus 802 and/or the processing system 914 of the apparatus 802′ configured to perform the functions recited by the aforementioned means.

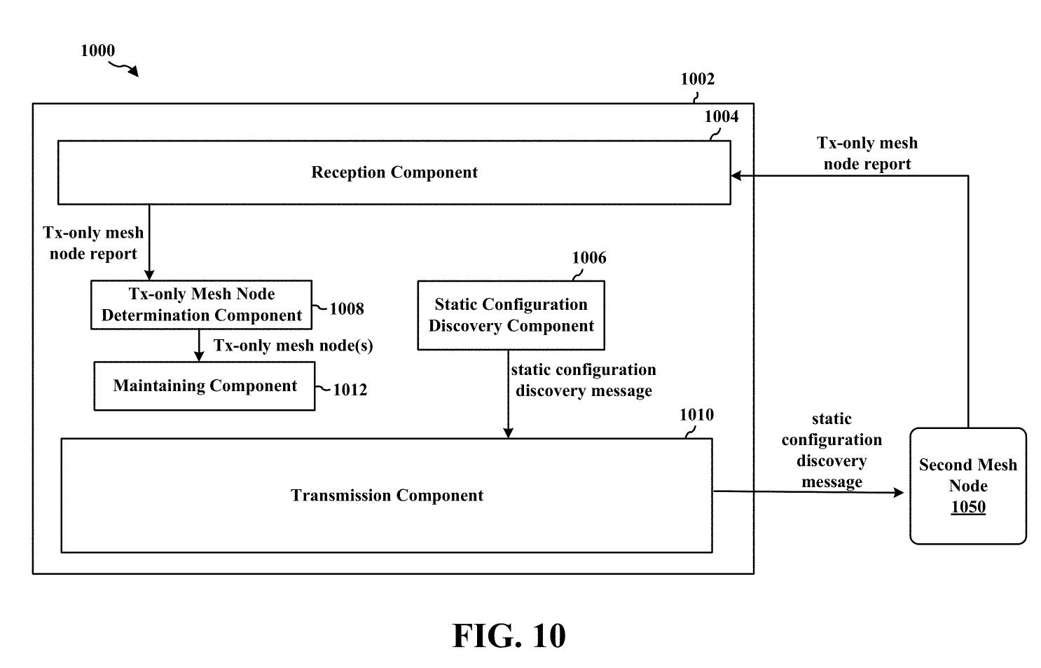

FIG. 10 is a conceptual data flow diagram 1000 illustrating the data flow between different means/components in an exemplary apparatus 1002. The apparatus may be a first mesh node (e.g., mesh client device 104, mesh node 102, the mesh node(s) 304, first mesh node 502, the apparatus 1002′) in communication with a second mesh node 1050 (e.g., mesh client device 104, mesh node 102, mesh node(s) 304, second mesh node 504). The apparatus may include a reception component 1004, a static configuration discovery component 1006, a Tx-only mesh node determination component 1008, a transmission component 1010, and a maintaining component 1012.

In certain configurations, the static configuration discovery component 1006 may be configured to request a report indicating any Tx-only mesh nodes within a WMN. In certain other configurations, the static configuration discovery component 1006 may be configured to generate a static configuration discovery message. In certain other configurations, the static configuration discovery component 1006 may be configured to send a signal associated with the static configuration discovery message to the transmission component 1010.

In certain configurations, the transmission component 1010 may be configured to transmit the static configuration discovery message to at least one second mesh node 1050. In one aspect, the static configuration discovery message may include a request for a report indicating any Tx-only mesh nodes.

In certain configurations, the reception component 1004 may be configured to receive, from the at least one second mesh node 1050, the report indicating any Tx-only mesh nodes. In one aspect, the report may include at least one source address, static security key, and destination address associated with at least one Tx-only mesh node. In certain other configurations, the reception component 1004 may be configured to send a signal associated with the report to the Tx-only mesh node determination component 1008.

In certain configurations, the Tx-only mesh node determination component 1008 may be configured to determine any Tx-only mesh nodes in the WMN based on the report. The Tx-only mesh node determination component 1008 may be configured to send a signal associated with the Tx-only mesh nodes (e.g., one or more respective source address(es), static security key(s), and/or destination address(es)) to the maintaining component 1012.

In certain configurations, the maintaining component 1012 may be configured to maintain a mapping of the source address(es), static security key(s), and/or destination address(es) with respective Tx-only mesh nodes.

The apparatus may include additional components that perform each of the blocks of the algorithm in the aforementioned flowchart of FIG. 7. As such, each block in the aforementioned flowchart of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

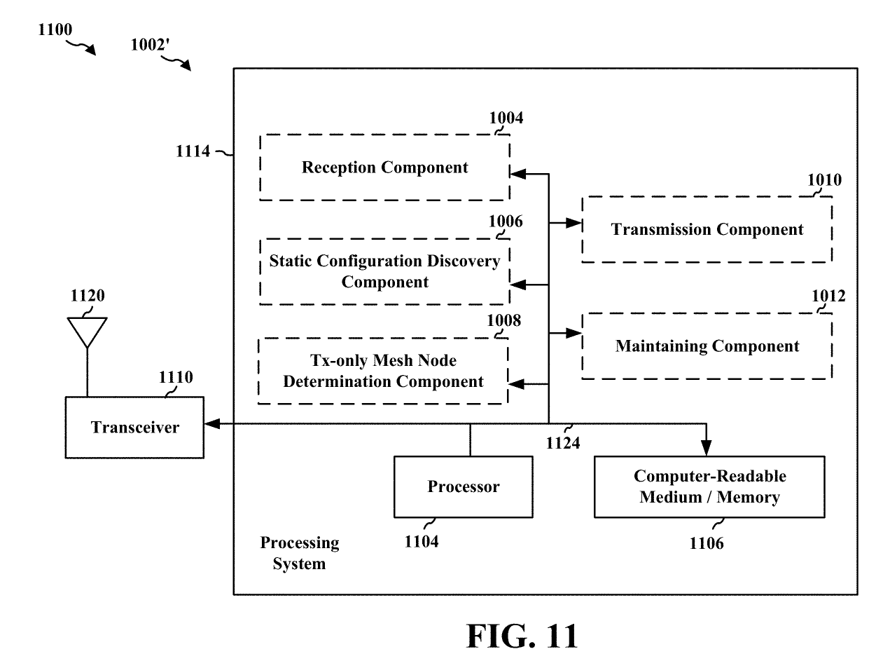

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006, 1008, 1010, 1012, and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the transmission component 1010, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the components 1004, 1006, 1008, 1010, 1012. The components may be software components running in the processor 1104, resident/stored in the computer readable medium/memory 1106, one or more hardware components coupled to the processor 1104, or some combination thereof.

In certain configurations, the apparatus 1002/1002′ for wireless communication may include means for transmitting a static configuration discovery message to at least one second mesh node. In one aspect, the static configuration discovery message may include a request for a report indicating any Tx-only mesh nodes. In certain other configurations, the apparatus 1002/1002′ for wireless communication may include means for receive, from the at least one second mesh node, the report indicating any Tx-only mesh nodes. In one aspect, the report may include at least one source address associated with at least one Tx-only mesh node. In certain other configurations, the apparatus 1002/1002′ for wireless communication may include means for determining any Tx-only mesh nodes in the WMN based on the report. In certain other configurations, the apparatus 1002/1002′ for wireless communication may include means for maintaining a mapping of the source address(es), static security key(s), and/or destination address(es) with respective Tx-only mesh nodes. The aforementioned means may be the processor(s) 202, the MMU 240, short-range communications controller 252, the radio 230, one or more of the aforementioned components of the apparatus 1002 and/or the processing system 1114 of the apparatus 1002′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication for a transmission-only mesh node in a mesh network, comprising:
determining a static security key associated with the transmission-only mesh node, the static security key including a message integrity code (MIC);
transmitting the static security key to at least one mesh node using a first frequency channel; and
transmitting at least one protocol data unit (PDU) to the at least one mesh node using a second frequency channel that is different than the first frequency channel.

2. The method of claim 1, further comprising:
performing a discovery procedure to establish a connection with the at least one mesh node.

3. The method of claim 2, wherein the discovery procedure includes one of a near-field communication (NFC) protocol or discovery based on a quick response (QR) code.

4. The method of claim 1, wherein the at least one PDU includes a sequence number associated with the transmission-only mesh node.

5. The method of claim 1, wherein the at least one PDU does not include a source address or a destination address.

6. The method of claim 1, wherein the PDU includes a first section that indicates a length of the PDU, a second section that indicates an advertisement data type, a third section that indicates a sequence number, a fourth section that includes a payload, and a fifth section that includes the static security key.

7. The method of claim 1, further comprising:
mapping a source address associated with the transmission-only mesh node, the static security key, and a destination address;
transmitting the mapping of the source address associated with the transmission-only mesh node, the static security key, and the destination address to the at least one mesh node.

8. A method of wireless communication for a first mesh node, comprising:
transmitting a static configuration discovery message to at least one second mesh node, the static configuration discovery message including a request for a report indicating any transmission-only mesh nodes;
receiving, from the at least one second mesh node, the report indicating any transmission-only mesh nodes;
determining any transmission-only mesh nodes in a wireless mesh network based at least in part on the report; and
maintaining information associated with any transmission-only mesh nodes included in the report.

9. The method of claim 8, wherein the report includes at least one source address associated with at least one transmission-only mesh node, a static security key, and a destination address, and wherein the information maintained by the first mesh node includes a mapping of the at least one source address associated with the at least one transmission-only mesh node, the static security key, and the destination address.

10. An apparatus for wireless communication for a transmission-only mesh node, comprising:
a memory; and
at least one processor coupled to the memory and configured to:
determine a static security key associated with the transmission-only mesh node, the static security key including a message integrity code (MIC);
transmit the static security key to at least one mesh node using a first frequency channel; and
transmit at least one protocol data unit (PDU) to the at least one mesh node using a second frequency channel that is different than the first frequency channel.

11. The apparatus of claim 10, wherein the at least one processor is further configured to:
perform a discovery procedure to establish a connection with the at least one mesh node.

12. The apparatus of claim 11, wherein the discovery procedure includes one of a near-field communication (NFC) protocol or discovery based on a quick response (QR) code.

13. The apparatus of claim 10, wherein the at least one PDU includes a sequence number associated with the transmission-only node.

14. The apparatus of claim 10, wherein the at least one PDU does not include a source address or a destination address.

15. The apparatus of claim 10, wherein the PDU includes a first section that indicates a length of the PDU, a second section that indicates an advertisement data type, a third section that indicates a sequence number, a fourth section that includes a payload, and a fifth section that includes the static security key.

16. The apparatus of claim 10, wherein the at least one processor is further configured to:
map a source address associated with the transmission-only mesh node, the static security key, and a destination address;
transmit the mapping of the source address associated with the transmission-only mesh node, the static security key, and the destination address to the at least one mesh node.

17. An apparatus for wireless communication for a first mesh node, comprising:
a memory; and
at least one processor coupled to the memory and configured to:
transmit a static configuration discovery message to at least one second mesh node, the static configuration discovery message including a request for a report indicating any transmission-only mesh nodes;
receive, from the at least one second mesh node, the report indicating any transmission-only mesh nodes;
determine any transmission-only mesh nodes in a wireless mesh network based at least in part on the report; and
maintain information associated with any transmission-only mesh nodes included in the report.

18. The apparatus of claim 17, wherein the report includes at least one source address associated with at least one transmission-only mesh node, a static security key, and a destination address, and wherein the information maintained by the first mesh node includes a mapping of the at least one source address associated with at least one transmission-only mesh node, the static security key, and the destination address.
